(19) United States
(12) Patent Application Publication
(10) Pub. No.: US 2001/0032915 A1
(43) Pub. Date: Oct. 25, 2001

(54) Clamping beverage container holder and other container supporting device

(76) Inventor: Valorie Clifford, Meridian, ID (US)

Correspondence Address: PEDERSEN & COMPANY, PLLC, P.O. BOX 2666, BOISE, ID, 83701, US

(21) Appl. No.: 09/772,838

(22) Filed: Jan. 29, 2001

Related U.S. Application Data
(60) Provisional application No. 60/178,893, filed on Jan. 28, 2000.

(51) Int. Cl. A47K 1/08; F16B 1/00

(52) U.S. Cl. 248/311.2; 248/229.25; 248/231.71; 248/315

(57) ABSTRACT

Disclosed is a combined beverage container holder and other container support, which combination clamps to a table desk or counter. The preferred device includes a cylinder for retaining a handled beverage container that attaches with a clamp on one side to an affixation point in an office, home or vehicular environment. On the other side of the holder, a preferably pivotal and removable support device provides support for a readily-removable trash container, tray or plant potter. The invented combination holder provides easy access to a beverage and to a trash container or other receptacle, so that a crafter or hobbyist, for example, need not clutter his/her work table with these objects or risk spilling a beverage on the work table.

### DESCRIPTION

This application claims priority from my prior, co-pending provisional patent application, U.S. Ser. No. 60/178,893, filed Jan. 28, 2000, and entitled the same as this application, which provisional patent application is hereby incorporated herein by reference.

### BACKGROUND OF THE INVENTION

1. Field of the Invention

The invention relates to a portable beverage container holder with a retention device on the holder for containers including trash bags. The invention has a clamp to be secured to virtually any horizontal planar surface, especially tables, desks and counter tops to provide organized support and disposal capability.

2. Related Art

Beverage holders come in a variety of shapes and sizes. In fact, most vehicle manufacturers equip their products with such devices for their consumers' convenience and safety. Hanging trash containers have also made their way into vehicular environments. However, a combination beverage receptacle and trash container hanger has yet to reach the office, the home or the vehicular environment. Examples of art in the field include: Wooters (U.S. Pat. No. D265,351), Flowers (U.S. Pat. No. D306,929) and Wallace et al. (U.S. Pat. No. 4,655,425).

Wooters '351 depicts a CUP HOLDER FOR AN AUTOMOBILE DOOR with a flap that permits the cup holder to hang from an automobile door.

Flowers '929 reveals a REFUSE AND BEVERAGE HOLDER FOR ATTACHMENT TO A LAWN MOWER OR THE LIKE. This design illustrates how a trash container would hang from a lawn mower crossbar with a cup holder affixed well below the trash container opening.

Wallace et al. '425 describes a UNIVERSAL CUP HOLDER. This design utilizes a resilient pusher element supported by the frame to engage the cup wall and urge the cup toward the retainer combined with a structure to attach the device to a vehicle door.

The instant invention distinguishes itself from the field for several reasons: Wooters '351 only provides for a cup holder that hangs from an automobile door. Its clamping apparatus has limited stability and does not provide for attachment to a protruding planar surface.

Flowers '929 combines a trash container with a beverage holder that merely hangs from a lawn mower crossbar. The design maintains no distinct clamping mechanism, and the beverage holder is below the container making it difficult to access and prone to contamination.

Wallace et al. '425 maintains a hanging attachment method similar to Wooters '351 and does not clamp to a horizontal surface. In addition, the device does not provide for a container hanger.

To date, no known device combines a receptacle for a beverage container with a retention device capable of supporting another object such as a trash container, a pen/pencil tray or plant potter in a home, office or vehicular environment. In fact, such a device would be especially useful for scrapbook makers, architects or graphic designers that utilize planar surfaces to produce work product. Such users typically have many small scraps of debris to discard on an ongoing basis. For these reasons, the present invention fulfills an important marketplace need.

### BRIEF SUMMARY OF THE INVENTION

This CLAMPING BEVERAGE CONTAINER HOLDER AND OTHER CONTAINER SUPPORTING DEVICE preferably comprises a holder for a beverage container that clamps or otherwise becomes secured to a planar surface within a home, office or vehicle environment, and provides an attached support device for a trash container, tray, planter or similar apparatus of reasonable weight.

The composition of the preferred device includes (1) a beverage container holder attached on one side to (2) a clamping or other securement mechanism for affixation of the holder to a stable surface and (3) a support device attached on the other side of the holder to support a trash container, tray, planter, or similar apparatus.

### BRIEF DESCRIPTION OF THE DRAWINGS

The drawings depict one embodiment of the invention. Other embodiments are possible.

FIG. 1 is a perspective view demonstrating how one embodiment of the invention may appear when affixed to a table or other ledge.

FIG. 2 is a side view of the embodiment portrayed in FIG. 1.

FIG. 3 is a top view of the embodiment portrayed in FIG. 1.

### DETAILED DESCRIPTION OF THE PREFERRED EMBODIMENT

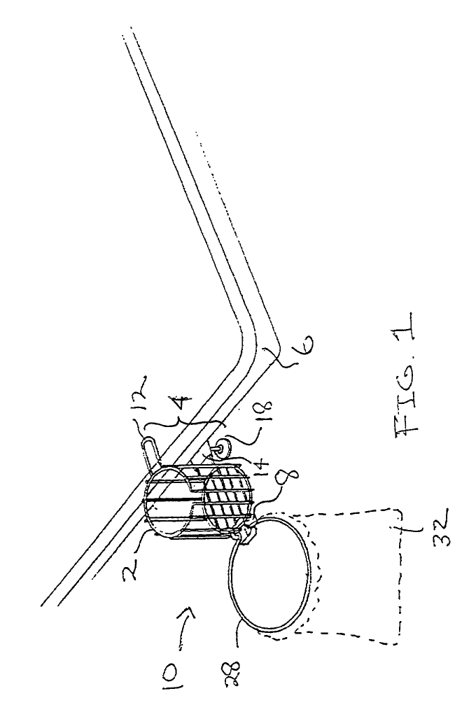

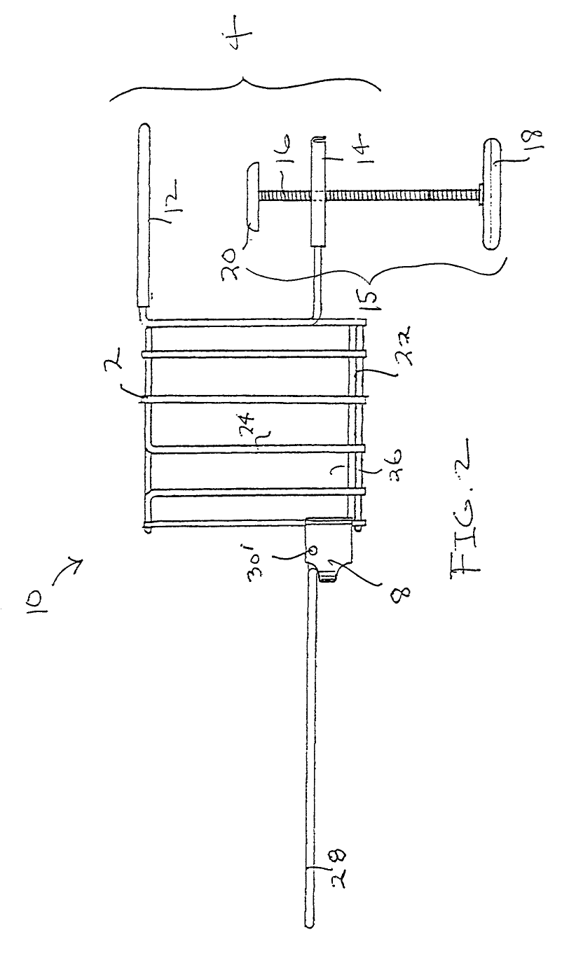

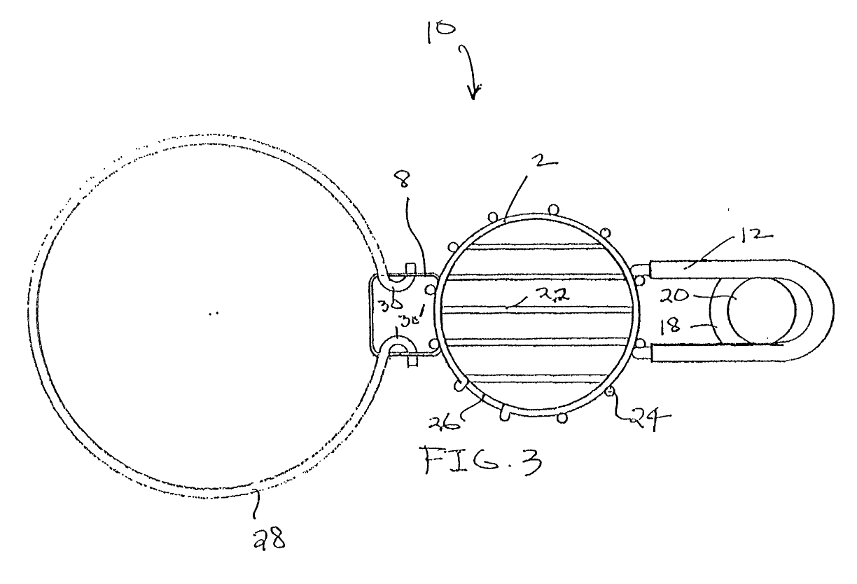

The figures depict one embodiment, and not all embodiments, of the CLAMPING BEVERAGE CONTAINER HOLDER AND OTHER CONTAINER SUPPORTING DEVICE of the present invention. FIG. 1 portrays an embodiment of the invention attached to a planar surface, while FIGS. 2 and 3 portray other views of the embodiment depicted in FIG. 1.

The device utilizes materials that provide significant strength without overbearing weight. Various metals and non-metallic materials meet this requirement, including plastics, aluminum and steel. One preferred embodiment uses plated steel rod sturdy wire, while alternative embodiments may utilize plastic-coated rod or wire, or may utilize injection-molded plastic to reduce production costs and increase affordability.

Referring to FIG. 1, the holder and container support 10 of the invention includes a beverage holder (2) with a clamping mechanism (4) for preferred affixation to a protruding table top (6), with a support device attached to one side of the holder (8) for a trash container (32).

FIG. 2 is a side view of the embodiment depicted in FIG. 1: Clamping mechanism (4) rigidly connects to one side of holder (2) and preferably includes a nonmar upper friction plate (12) and a lower plate (14) for supporting a screw driven friction apparatus (15). The screw driven apparatus (15) has a threaded rod (16) with a circular turning handle (18) and a non-mar circular lower friction plate (20). Moving the circular turning handle clockwise or counter-clockwise increases or decreases tension on the attachment point to affix or remove the device. Another alternative method of clamping would involve a spring loaded clip attached to upper friction plate (12) or lower plate (14) to provide rapid affixation or removal. In fact, various clamping or other securement methods may achieve the intended attachment. For example, the securement means may be a horizontal tab with a downwardly extending tip at its distal end. This way, the holder may be secured to the front of a closed drawer of a desk or cabinet. Or, the securement means may be a fixed or adjustable tong with two horizontal members, one for engaging the top surface of a table desk or counter top, and the other for engaging the bottom surface.

Holder (2) includes a top opening, bottom (22) and sidewalls (24), which may be constructed from wires or rods to form a type of “wire cage” or which may be constructed from solid substantially continuous materials. With the “wire cage” construction, a beverage container is visible to the user through the rods or wires and the holder (2) is easily cleaned of any spills or drips. Preferably, a vertical slot (26) extends through the sidewall of the holder (2) for receiving a handle of a mug or other beverage container.

Preferably, the clamping mechanism (4) is attached to the holder (2) approximately midway down on the side of the holder, rather than below or above the holder(2), to position the opening of the holder about level with the surface to which the invented device is clamped. The plane of the opening preferably rests at, or near, the plane of the tables, desk or counter top to which the holder is secured to mitigate work space interference or unintentional spillage.

Bottom plate (22) provides support for objects, like beverage cups or bottles, placed in cylindrical holder (2). Vertical slot (26) extends from a location near the bottom (24) to the top opening of holder (2) and provides a space to retain the handle of a beverage container. The currently preferred version of holder (2) uses vertical steel rods for sidewalls (24) and horizontal steel rods for bottom (22) to support and substantially surround a common drinking mug. An alternative version may have more solid sidewalls for better insulation. As depicted in FIG. 3, the preferred holder (2) is sized to receive a coffee/beverage mug with the mug handle extending through the slot (26) for easy access by the user.

Holder and container support (10) includes a rigid support device (8) attached to holder (2), in this case on a side opposite from clamping mechanism (4). Support device (8) has a mounting point for a pivotal hanger (28) placed at, or near, the plane of bottom plate (22). Placing hanger (28) low on holder (2) provides an ergonomic design which enables the user to comfortably access an item within holder (2) over hanger (28). Also, placing the hanger (28) low on the holder (2) helps distance trash, for example, from the user's beverage. Preferably, the hanger (28) pivots from the horizontal position shown in the Figures up to an upright position near the sidewalls (24) of the holder (2). The pivoting mechanism rests the hanger (28) in an approximate horizontal plane for normal use, while allowing a vertical placement for storage or for other times when the hanger (28) is not in use.

FIG. 3 better illustrates a preferred shape for hanger (28): Here, the depicted hanger's (28) circular shape permits retention of a common plastic shopping bag for use as a trash container. The opposing “U” shaped attachment means (30, 30′) permits rapid attachment or detachment (removal) of hanger (28) by inward force, while also allowing pivoting action of the hanger (28) relative to the holder (2). Thus, the connection mechanism between the hanger (28) and holder (2) is both pivotal and detachable. A multitude of ovoid or rectangular or other hanger shapes may be used for suspension of a trash container (32), or other items such as a pen or pencil tray or a plant potter.

Although this invention has been described above with reference to particular means, materials and embodiments, it is to be understood that the invention is not limited to these disclosed particulars, but extends instead to all equivalents within the scope of the following claims.

I claim:

1. A combination beverage container holder and other container supporting device, comprising:
a beverage container holder;
a securement mechanism attached on one side of said beverage container holder for securing said holder to a table, desk or counter top; and
a support device attached on another side of said beverage container holder for supporting a tash container, tray, planter, or similar apparatus.

2. The combination holder of claim 1 wherein the securement mechanism is a screw-driven clamp.

3. Claim 1 wherein the securement mechanism is a spring-loaded clip.

4. The combination holder of claim 1 wherein the support device comprises a pivoted hanger for supporting the trash container, tray, planter or similar apparatus.

5. The combination holder of claim 1 wherein the beverage container holder comprises a bottom wall and sidewalls, and an open top for receiving a beverage container, and a generally vertical slot in the sidewalls for receiving a handle of the beverage container.

6. The combination holder of claim 5 wherein the beverage container holder is a wire cage comprising a bottom plate of generally horizontal wires and sidewalls of generally vertical wires.

7. The combination holder for claim 5 wherein the securement mechanism is attached generally midway on one side of said beverage container holder for securing said holder to a table, desk or counter top so that the combination holder is securable to the table, desk or counter top so that the opening is level with a top surface of said table, desk or counter top.

8. The combination holder of claim 1 wherein said support device comprises a generally circular, generally horizontal wire loop surrounding and defining a central space for receiving the trash container, tray, planter, or similar apparatus.

9. The combination holder of claim 8 wherein the wire loop is pivotal from a generally horizontal position to a generally vertical position.

10. The combination holder of claim 8 wherein the support device comprises a detachable and pivotal connection mechanism detachably connecting the support device to the beverage container holder.

11. The combination holder of claim 10 wherein the detachable and pivotal connection mechanism comprises two opposing U-shaped attachment members on the support device that are pivotally and removably received by a rigid portion of the beverage container holder.

12. The combination holder of claim 1 wherein the beverage container holder has a bottom, and wherein the support device is attached to said beverage container holder near said bottom so that the trash container, tray, planter, or similar apparatus is suspended substantially below the beverage container holder.
